(19) United States
(12) Patent Application Publication
(10) Pub. No.: US 2010/0195228 A1
(43) Pub. Date: Aug. 5, 2010

(54) FUNCTIONAL FIELD OF VIEW FOR BLIND SPOT MIRRORS

(75) Inventors: Gary J. Sinelli, Birmingham, MI (US); Michael E. Karpus, Macomb, MI (US); Douglas J. Wilson, Fort Gratiot, MI (US); Paul R. Henion, Port Huron, MI (US); Brian Glombowski, Clyde Township, MI (US)

Correspondence Address: REISING ETHINGTON P.C., P O BOX 4390, TROY, MI, 48099-4390, US

(73) Assignee: SMR Patents S.a.r.l., Luxembourg (LU)

(21) Appl. No.: 12/697,476

(22) Filed: Feb. 1, 2010

Related U.S. Application Data
(60) Provisional application No. 61/148,404, filed on Jan. 30, 2009.

(51) Int. Cl. G02B 5/08

(52) U.S. Cl. 359/866

(57) ABSTRACT

An exterior rearview mirror assembly for a motor vehicle includes a mounting bracket securable to a lateral side of a vehicle. A mirror case is secured to the mirror bracket. A primary reflector is fixedly secured to the primary portion of the backing plate. The primary reflector defines a primary field of view extending laterally away from the lateral side of the motor vehicle. A secondary reflector defines a secondary field of view extending laterally in space disposed adjacent the lateral side of the motor vehicle, wherein the secondary field of view overlaps the primary field of view in a range of 20% to 80%. The field of view of the secondary reflector is also directed downwardly with respect to the field of view of the primary reflector.

This patent application claims priority to a U.S. provisional patent application having Ser. No. 61/148,404, which is hereby incorporated by reference.

### BACKGROUND ART

1. Field of the Invention

The invention relates to exterior rearview mirror assembly assemblies for motor vehicles. More particularly, the invention relates to exterior rearview mirror assembly assemblies that incorporate primary and secondary reflectors to increase the overall viewing area provided by the exterior rearview mirror assembly.

2. Description of the Related Art

Secondary reflectors on exterior rearview mirror assemblies are commonly referred to as blind spot mirrors. In such exterior rearview mirror assemblies, a primary reflector is known as the Main Viewing Glass and the secondary reflector also know as a Blind Spot Mirror. Automotive manufacturers often provide blind spot mirrors on the vehicle they sell because it is well known that a ‘blind zone’ (or blind spot) exists immediately adjacent the lateral sides of the vehicle. This blind zone is the area that starts where the field of view of the primary reflector ends and continues to the point where the driver can see the object through his or her peripheral vision. By providing this secondary reflector, automotive manufacturers reduce or eliminate this ‘blind zone.’

In some cases, this secondary reflector is mounted separately from the primary reflector and thus is independently adjustable therefrom. With this configuration, adjusting the secondary reflector to a position that provides a satisfactory field of view becomes an easy matter and does not impact the driver's preference on the positioning of the primary reflector. However, in other cases, the secondary reflector is mounted on the same backing plate, or carrier, as the primary reflector. Is such designs, the secondary reflector is not independently adjustable from the primary reflector. Therefore, after the driver adjusts the exterior mirror such that the primary reflector is in the desired position, the field of view of the secondary reflector is fixed and cannot be adjusted. In numerous production models that exist, there is dissatisfaction in the positioning of this secondary reflector.

The nominal position of the primary reflector is determined by those skilled in the art and the means to determine this are well known within the industry. Federal Regulations provide guidelines in this process and the end result must meet these regulations. However, determining the nominal position for a secondary reflector is not regulated and attempts at orienting the secondary reflector vis-à-vis the primary reflector have been made that resulted in less than satisfactory results.

### SUMMARY OF THE INVENTION

An exterior rearview mirror assembly is mounted to a motor vehicle having a forward end, a back end and a lateral side. The exterior rearview mirror assembly includes a mounting bracket fixedly securable to a lateral side of the motor vehicle. A mirror case is secured to the mirror bracket. The mirror case defines a housing having a closed side facing the forward end of the motor vehicle and a primary opening facing the back end. A backing plate is movably secured within the mirror case. The backing plate includes a primary portion and a secondary portion. A primary reflector is fixedly secured to the primary portion of the backing plate. The primary reflector defines a primary field of view extending laterally away from the lateral side of the motor vehicle. A secondary reflector is fixedly secured to the secondary portion of the backing plate. The secondary reflector defines a secondary field of view extending laterally in space disposed adjacent the lateral side of the motor vehicle, wherein the secondary field of view overlaps the primary field of view in a range of 20% to 80%.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of one embodiment of the invention;

FIG. 2 is a top view of a motor vehicle, partially cut away, incorporating the invention, wherein the drawing includes lines representing various lines of sight;

FIG. 3 is a top view of a motor vehicle, partially cut away, incorporating the invention, and another vehicle positioned with respect to the motor vehicle, wherein the drawing includes lines representing various lines of sight;

FIG. 4 is a side view of an operator of a motor vehicle with line of sight lines between the operator and the invention; and

FIG. 5 is a side view of a motor vehicle incorporating the invention, and another vehicle positioned with respect to the motor vehicle, wherein the drawing includes lines representing various lines of sight.

### DETAILED DESCRIPTION OF THE PREFERRED EMBODIMENTS

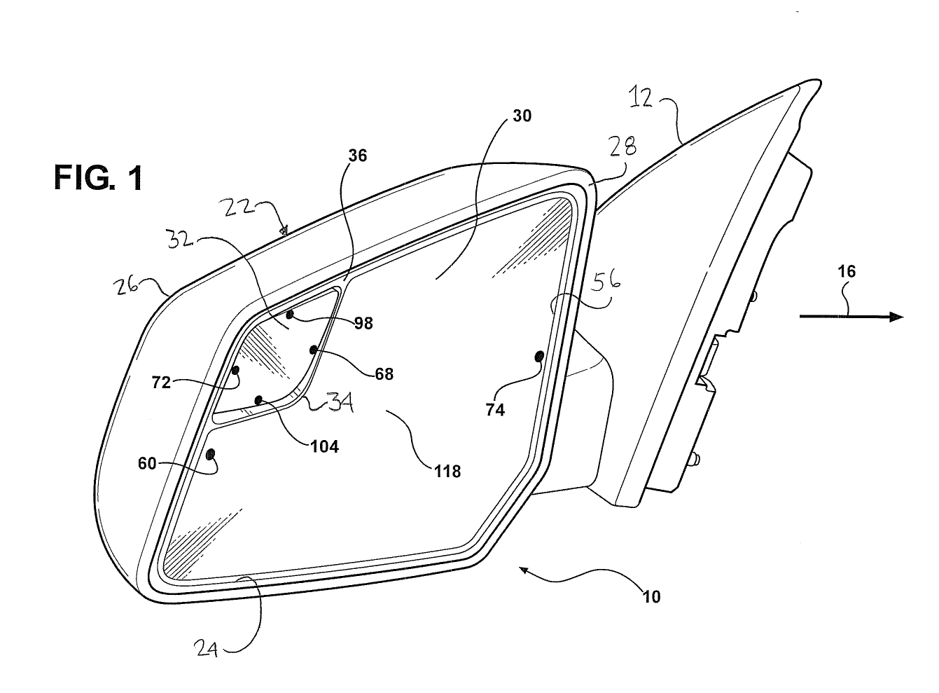

Referring now to the drawings, FIG. 1 shows the detail of an exterior rearview mirror assembly 10 incorporating the invention. The exterior rearview mirror assembly 10 includes a mounting bracket 12 that secures the exterior rearview mirror assembly 10 to a lateral side 14 of a motor vehicle 16. The motor vehicle 16 defines a forward end 18 and a back end 20. The motor vehicle 16 includes a second lateral side (not shown), typically with a passenger side exterior rearview mirror assembly secured thereto. While the passenger side exterior rearview mirror assembly typically would not include the invention, it may if it were so designed.

A mirror case or housing, generally indicated at 22, is secured to the mounting bracket 12. The mirror case 22 defines a primary opening 24 that faces rearward with respect to the forward motion of the motor vehicle 16. The mirror case 22 includes a forward face 26 that wraps around the primary opening 24 to create a mirror frame 28 disposed around the primary opening 24. A primary reflector 30 and a secondary reflector 32 are visible through the primary opening 24. A bridge 34 between the primary 30 and secondary 32 reflectors helps distinguish the border shared therebetween. However, a bridge may not always be present. It should be appreciated by those skilled in the art that the exterior rearview mirror assembly 10 may include fewer or more features, depending on the design and package choices and those features do not add or detract from the inventive method.

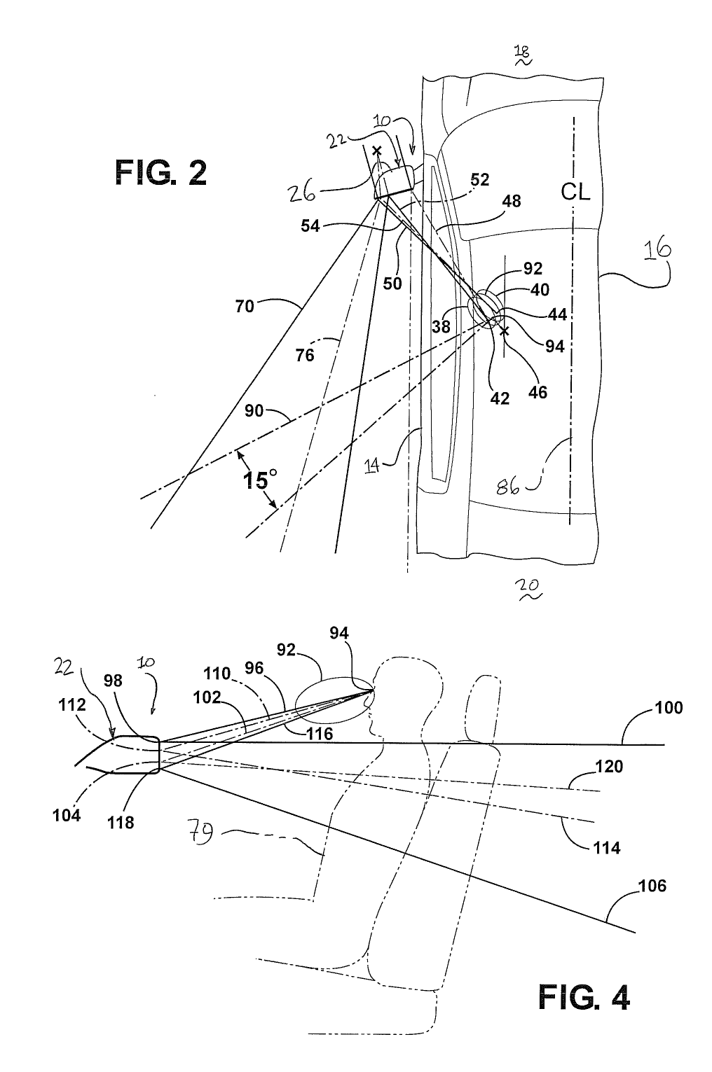

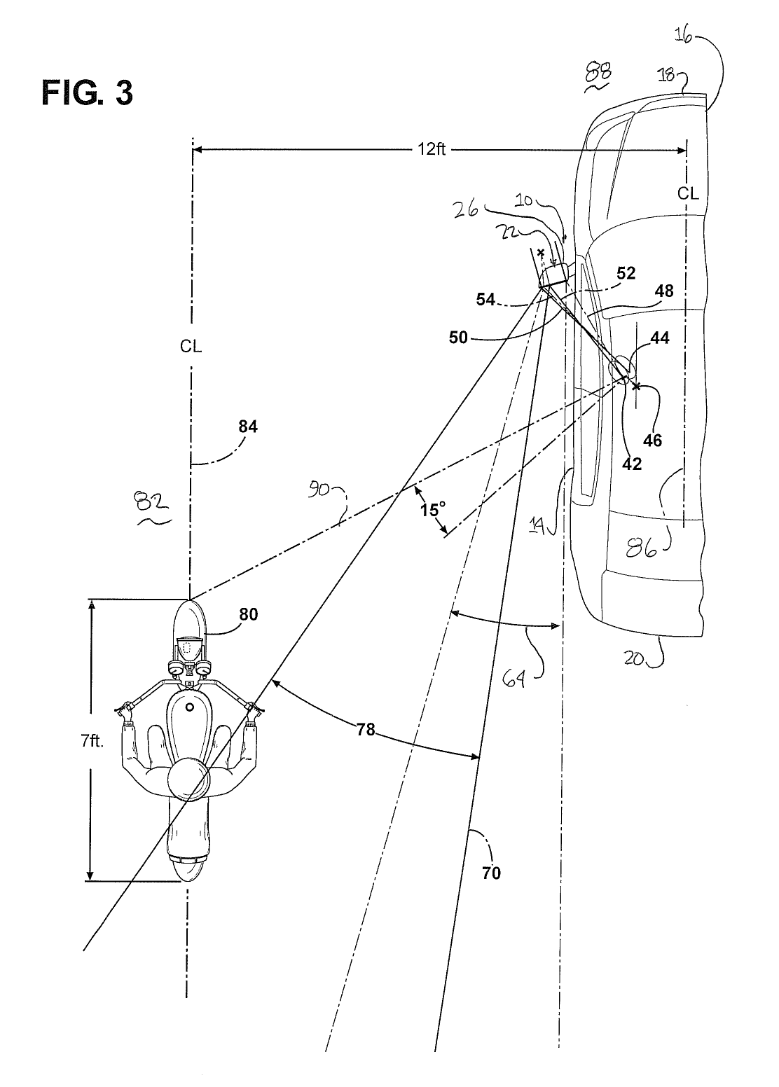

The primary 30 and secondary 32 reflectors are mounted to a backing plate 36. It is understood that the backing plate 36 is movably secured to the exterior rearview mirror assembly 10. In the preferred embodiment, there is no need for a second backing plate for the secondary reflector 32. FIGS. 2 and 3 show the plan view and the side view respectively of the design elements of the invention.

The primary reflector 30 may be flat or convex. The secondary reflector 32 is highly convex and provides a greater field of view than the primary reflector 30. For the remainder of the discussion, the backing plate 36, and, hence, the primary reflector 30 and the secondary reflector 32 are fixed in a predetermined orientation for purposes of determining the respective fields of view for the two reflectors 30, 32. This fixed position is commonly called the “Design Nominal Position.”

FIGS. 2 and 3 may be looked at concurrently as FIG. 2 is an enlarged view of the detail that is not easily discernable within FIG. 3. In FIGS. 2 and 3, a pair of ellipses 38, 40 defines locations relating to or representing where 95% of the eyes of all drivers are with respect to the exterior rearview mirror assembly 10. Eye points 42, 44 are defined within the eye ellipses 38, 40. In this Figure, the eye points 42, 44 have been rotated about a neck point 46 to look at the view in the exterior rearview mirror assembly 10. From eye points 42, 44, lines of sight 48, 50, 52, 54 extend outward toward the primary reflector 30 and the secondary reflector 32. In particular, the line of sight 48 extends from eye point 42 to an inboard edge 56 of the primary reflector 30 and that line of sight 48 is reflected rearward and represented by line of sight 58, which is also referred to as the inboard boundary of the field of view for the primary reflector 30. The line of sight 50 extends from the eye point 44 to an outboard edge 60 of the primary reflector 30 and that line of sight is reflected rearward and represented by a line of sight 62, which is referred to as the outboard boundary of the field of view for the primary reflector 30. Thus, the primary field of view 64 for the primary reflector 30 is defined can be represented by the angle between the boundaries represented by lines of sight 58, 62.

Similarly, a line of sight 66 extends between the eye point 42 and an inboard edge of the secondary reflector 32 and that line of sight 66 is reflected rearward and shown as a line of sight 70, which is referred to as the inboard boundary of the field of view for the secondary reflector 32. The line of sight 54 extends from the eye point 44 to an outboard edge 72 of the secondary reflector 32, and that line of sight is reflected rearward and shown as a line of sight 76, which is referred to as the outboard boundary of the field of view for the secondary reflector 32. Thus, the secondary field of view 76 for the secondary reflector 32 can be represented by the angle between boundaries represented by lines of sight 70, 76. It will also be in FIG. 2 that line of sight 66 that reflects off the inboard edge 68 of the secondary reflector 32 goes generally rearward providing a view of vehicles 80 traveling in a passing lane 82 adjacent to the motor vehicle 16 being driven. This passing lane 82 adjacent is generally shown in FIG. 2 by its centerline 84. The centerline 84 is defined as being a distance of 12 feet from a centerline 86 of a lane 88 in which the motor vehicle 16 is traveling. The field of view 78 provided by the secondary reflector 32 extends significantly far behind the driven motor vehicle 16 and it has also been determined that a driver 79 of the driven motor vehicle 16 will be able to achieve a reference of the vehicle 80 traveling in the passing lane 82 because the driver 79 will be able to see the passing vehicle 80 within the primary field of view 64 of the primary reflector 30 and concurrently see the same passing vehicle 80 within the secondary field of view 78 of the secondary reflector 32.

Also shown in FIGS. 2 and 3 is a line 90 representing outer bounds of the peripheral vision of the driver 79. For the purposes of this drawing, the peripheral vision line 90 has been established at an angle 75 degrees from the driver's forward view. Another way of describing the peripheral vision boundary line 90 is that it is 15 degrees from a line drawn which bisects the two eye points 42, 44. Those skilled in the art will realize that the average person has more than 75 degrees of peripheral vision; however, 75 degrees of peripheral vision allows for a safety margin.

The passing vehicle 80 is shown to be a motorcycle that is seven feet long. This represents perhaps the smallest and shortest motorized vehicle that may be present on a two lane road or highway. This small passing vehicle 80 is still viewable within the field of view of the secondary reflector 32 as it is entering into the peripheral view 90 of the driver 79, thus eliminating the blind spot or zone.

Stating it another way, with this given set of parameters, the driver 79, when looking at the reflection in the secondary reflector 32 will be able to see the vehicle 80 in the adjacent lane 84 in both his primary reflector 30 and his secondary reflector 32 for an extended period of time providing a reference in the mind of the driver 79 to establish the relative position of the passing vehicle 80. As the vehicle 80 continues to pass the driven vehicle 16, at the critical point the driver 79 is able to see the passing vehicle 80 in both the secondary reflector 32 and through his peripheral vision because a portion of the passing vehicle 80 has crossed the boundary 90 defining where the peripheral vision of the driver 79 starts.

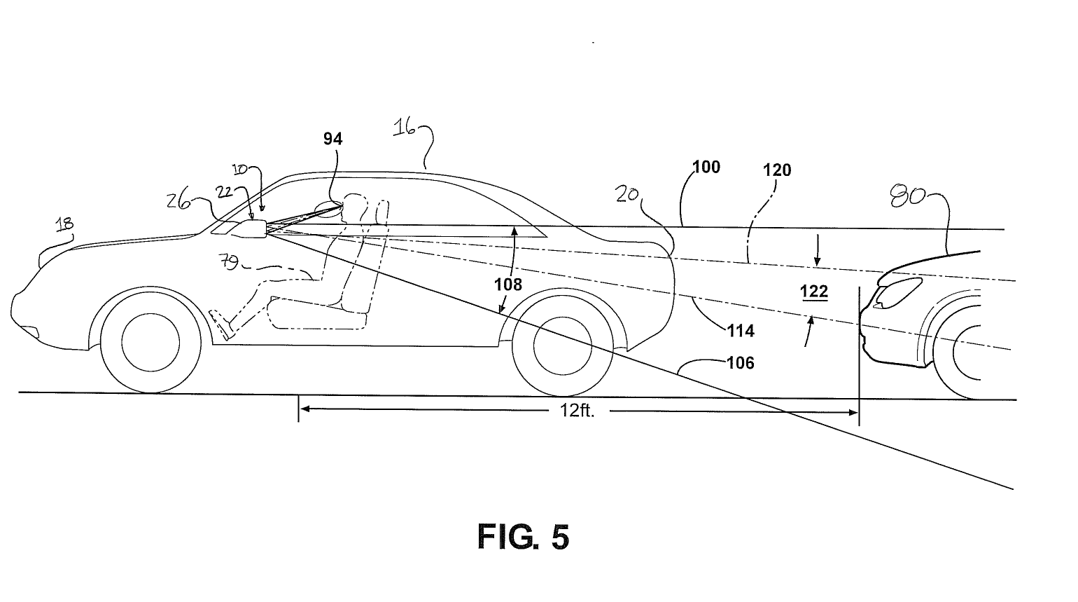

FIGS. 4 and 5 may be looked at concurrently as FIG. 4 is a close up view of the detail that is not easily discernable within FIG. 5. FIGS. 4 and 5 show the side view of driven vehicle 16 and the resultant lines of sight from a determined point within the eye ellipse 38, 40 to the primary reflector 30 and the secondary reflector 32 and how they are reflected rearward. For clarity and the purposes of this discussion, an eye ellipse 92 shown in FIG. 2 is an average of the two eye ellipses 38, 40 discussed above. Also, an eye point 94 is an average of eye points 42, 44. Returning back to FIGS. 4 and 5, it is seen that a line of sight 96 extends from eye point 94 to an upper edge 98 of the secondary reflector 32. This line of sight is reflected rearward and shown as a line of sight 100. A line of sight 102 extends from the eye point 94 to a lower edge 104 of the secondary reflector 32, and that line of sight is reflected rearward and shown as a line of sight 106. These reflected lines of sight 100, 106 define a secondary side field of view 108 for the secondary reflector 32 and is represented by the angle between the reflected lines of sight 100, 106. It will also be seen that that a line of sight 110 extends from the eye point 94 to a center 112 of the secondary reflector 32 and that line of sight 112 is reflected rearward and shown as a center reflected line of sight 114, which can also be defined as the field of view center line 114 for the secondary reflector 32.

FIGS. 4 and 5 also shows line of sight 116 extends from eye point 94 to an approximate center 118 of the primary reflector 30 and that line of sight is reflected rearward and shown as a reflected line of sight 120, which can also be defined as the field of view center line for the primary reflector 30. An angle 122 is defined by the difference in direction (aiming) from the reflected line of sight 114 of the secondary reflector 32 and reflected line of sight 120 of the primary reflector 30.

It can be seen that the reflected line of sight 120 points somewhat downward due to Government Regulations. However, those skilled in the art will realize that the average driver 79 tends to adjust his primary reflector 30 such that the center of his field of view tends to point at the horizon line. The extent to which the driver 79 make this adjustment tends to be more for taller vehicles and less for shorter vehicles. Those skilled in the art will also know that the degree with which the reflected line of sight 120 points downward is greater for taller vehicles than it is for shorter vehicles. For this reason, the secondary reflector 32 is positioned or aimed such that field of view centerline 114 of the secondary reflector 32 is below the field of view center line 120 of the primary reflector 30 by the amount of angle 122. This angle is typically 5 degrees but can be defined as a range of 3 to 7 degrees.

If the secondary reflector 32 were aimed at a target while the backing plate 36 is held in the design nominal position, adjusting the mirror upward as is typically done (and defined above) would result in the secondary reflector 32 no longer able to clearly see the preferred target which would result in customer dissatisfaction.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. An exterior rearview mirror assembly 10 assembly for a motor vehicle having a forward end, a back end and a lateral side, said exterior rearview mirror assembly 10 assembly comprising:
a mounting bracket fixedly securable to the lateral side of the motor vehicle;
a mirror case secured to said mirror bracket, said mirror case defining a housing having a closed side facing the forward end of the motor vehicle and a primary opening facing the back end;
a backing plate movably secured within said mirror case, said backing plate including a primary portion and a secondary portion;
a primary reflector fixedly secured to said primary portion of said backing plate, said primary reflector defining a primary field of view extending laterally away from the lateral side of the motor vehicle; and
a secondary reflector fixedly secured to said secondary portion of said backing plate, said secondary reflector defining a secondary field of view extending laterally in space disposed adjacent the lateral side of the motor vehicle wherein said secondary field of view overlaps said primary field of view in a range of 20% to 80%.

2. An exterior rearview mirror assembly 10 assembly as set forth in claim 1 wherein said primary field of view defines a primary centerline and said secondary field of view defines a secondary centerline wherein said secondary centerline is below said primary centerline in a range between 3 degrees and 7 degrees.

3. An exterior rearview mirror assembly 10 assembly for a motor vehicle having a forward end, a back end and a lateral side, said exterior rearview mirror assembly 10 assembly comprising:
a mounting bracket fixedly securable to the lateral side of the motor vehicle;
a mirror case secured to said mirror bracket, said mirror case defining a housing having a closed side facing the forward end of the motor vehicle and a primary opening facing the back end;
a backing plate movably secured within said mirror case, said backing plate including a primary portion and a secondary portion;
a primary reflector fixedly secured to said primary portion of said backing plate, said primary reflector defining a primary field of view having a primary centerline; and
a secondary reflector fixedly secured to said secondary portion of said backing plate, said secondary reflector defining a secondary field of view having a secondary centerline wherein said secondary centerline is below said primary centerline in a range between 3 degrees and 7 degrees.
